(19) United States
(12) Patent Application Publication
(10) Pub. No.: US 2005/0287289 A1
(43) Pub. Date: Dec. 29, 2005

(54) APPARATUS AND METHOD FOR COATING ORGANIC MATERIAL

(76) Inventors: Chi-Kuei Liao, Kaohsiung County (TW); Szu-Houng Lin, Hsinchu City (TW)

Correspondence Address: JIANQ CHYUN INTELLECTUAL PROPERTY OFFICE, 7 FLOOR-1, NO. 100, ROOSEVELT ROAD, SECTION 2, TAIPEI, 100, TW

(21) Appl. No.: 10/711,569

(22) Filed: Sep. 25, 2004

(30) Foreign Application Priority Data
Jun. 18, 2004 (TW) 93117606

(51) Int. Cl. B05D 5/12; B05C 1/08

(52) U.S. Cl. 427/66; 118/258

(57) ABSTRACT

An apparatus and a method of coating organic material over an organic electro-luminescent device is provided. A substrate having an electrode layer formed thereon is provided. An organic material is coated on the electrode layer by the apparatus of the present invention. The apparatus comprises at least an organic material storage element having an ejection hole and a rolling element. The rolling element is disposed in the ejection hole such that an organic material stored in the organic material storage element flows out by rolling the rolling element. The apparatus of the present invention is capable of reducing the process time and the manufacturing costs.

### CROSS-REFERENCE TO RELATED APPLICATION

This application claims the priority benefit of Taiwan application serial no. 93117606, filed Jun. 18, 2004.

### BACKGROUND OF THE INVENTION

1. Field of the Invention

The present invention relates to an apparatus and method for coating a material, and more particularly to an apparatus and method for coating an organic material for forming an organic functional material layer of an organic electro-luminescent device.

2. Description of the Related Art

Flat panel displays serve as interface between users and electronic devices. So far, flat panel displays include organic electro-luminescent displays, plasma display panels (PDPs), liquid crystal displays (LCDs), light emitting diode (LED) displays, vacuum fluorescent displays (VFDs), field emission displays (FEDs) and electro-chromic displays, etc . . . . With advantages such as self-luminescence, wide view angles, low power consumption, simple processes, low costs, wide operational temperature, high response speed and full colors., organic electro-luminescent displays have attracted more attention and is expected to gradually become more promising next-generation displays.

Organic electro-luminescent displays perform by the self-luminescence characteristics of the organic functional layers. The luminescent structure includes a pair of electrodes and an organic functional layer. The organic functional layer includes a hole transport layer (HTL), an emission layer (EL) and an electron transport layer (ETL). When current flows through the transparent anode and the metal cathode, the combination of electrons and holes within the organic functional layer generates excitons. According to the properties of the organic functional layer, the organic functional layer illuminates different colors.

Traditionally, the formation of the organic functional layer is related to the properties thereof. For example, the organic functional layer is formed by an ink-jet printing process or a spin-coating process. Ink-jet printing process dispenses the organic functional layer on the electrode layer via an ink-jet head cooperated with a control system. The design of the ink-jet head, however, is too complicated. Due to its complication, it is difficult to maintain or to operate the ink-jet head. The equipment cost is also high. Throughput of coating the organic functional layers on larger substrates will be decreased.

Spin-coating process coats the organic functional layer over the substrate by the centrifugal force generated from rotation. Compared with ink-jet printing process, spin-coating process has a simple process, large-area coating, high throughput and low equipment costs. After spin coating process, only 2% organic material is retained on the substrate and about 98% organic material is spun out off the substrate. That results in the organic material waste issue. Furthermore, as the size of display becomes larger, spin-coating process cannot well control the uniformity of the organic functional layer when applied to the large-size substrate. Equipment costs are thus increased significantly.

### SUMMARY OF THE INVENTION

Accordingly, the present invention is directed to an apparatus for coating an organic material capable of reducing wasting of the organic material.

The present invention is also directed to an apparatus for coating an organic material capable of resolving the issue of low throughput when applied to the large-size substrate.

The present invention is directed to a method of coating an organic material for reducing the wasting of organic materials.

The present invention is also directed to a method of coating an organic material capable of resolving the issue of low throughput when applied to the large-size substrate.

According to an embodiment of the present invention, an apparatus suitable for coating an organic functional layer of an organic electro-luminescent device is provided. The apparatus includes an organic material storage element and a rolling element. The organic material storage element has an ejection hole. The rolling element is disposed in the ejection hole. An organic material flows out from the organic material storage element by rolling the rolling element.

According to another embodiment of the present invention, the apparatus includes a plurality of organic material storage elements and an organic material supply apparatus. Each of the organic material coating elements includes an organic material storage element and a rolling element. The organic material storage element has an ejection hole. The rolling element is disposed in the ejection hole. An organic material flows out from the organic material storage element by rolling the rolling element. The organic material supply apparatus is coupled to the elements of the organic material coating elements.

The present invention discloses a method of coating an organic functional material layer of an organic electro-luminescent device. First, a substrate having an electrode layer formed thereon is provided. An organic material is coated over the electrode layer by an apparatus includes an organic material storage element and a rolling element. The organic material storage element has an ejection hole. The rolling element is disposed in the ejection hole. The organic material flows out from the organic material storage element by rolling the rolling element.

According to another embodiment of the present invention, first, a substrate having an electrode layer formed thereon is provided. An organic material is coated over the electrode layer by an apparatus comprising a plurality of organic material storage elements and an organic material supply apparatus. Each of the organic material coating elements includes an organic material storage element and a rolling element. The organic material storage element has an ejection hole. The rolling element is disposed in the ejection hole. An organic material flows out from the organic material storage element by rolling the rolling element. The apparatus is coupled to the organic material storage elements of the organic material coating elements.

The organic material can be coated on the electrode layer by the apparatus of the present invention via either a contact coating method or a non-contact coating method. Accordingly, as the utilization of the organic material increases, manufacturing cost decreases and accordingly, the apparatus of the present invention is suitable for mass production. The apparatus of the present invention is also capable of effectively reducing the process time for large substrate coating.

In order to make the aforementioned and other objects, features and advantages of the present invention understandable, a preferred embodiment accompanied with figures is described in detail below.

### BRIEF DESCRIPTION OF THE DRAWINGS

FIG. 1 is a schematic drawing showing an apparatus for coating organic material according to an embodiment of the present invention.

FIG. 2A is a schematic magnified view of the ejection hole 102 of the apparatus shown in FIG. 1.

FIG. 2B is another schematic magnified view of the ejection hole 102 of the apparatus shown in FIG. 1.

FIG. 3 is a schematic magnified view of the rolling element shown in FIG. 2A.

FIG. 4 is a schematic drawing showing a method of coating the organic material on a passive electro-luminescent device according to an embodiment of the present invention.

FIG. 5 is a schematic drawing showing a method of coating the organic material on a passive electro-luminescent device according to another embodiment of the present invention.

### DESCRIPTION OF SOME EMBODIMENTS

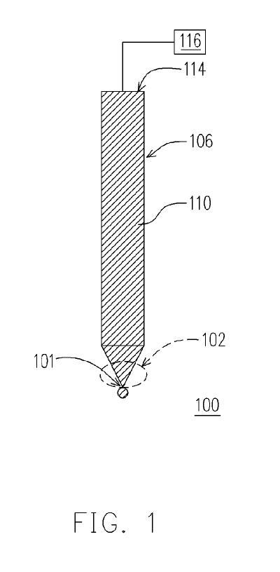

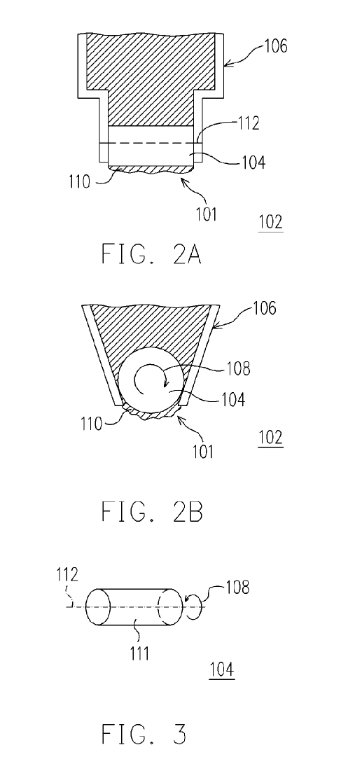

FIG. 1 is a schematic drawing showing an apparatus suitable for coating organic material according to an embodiment of the present invention. FIG. 2A is a schematic magnified view of the ejection hole 102 of the apparatus shown in FIG. 1. FIG. 3 is a schematic magnified view of the rolling element of the apparatus shown in FIG. 2A.

Referring to FIGS. 1, 2A and 3, the apparatus suitable for coating an organic functional material layer of the organic electro-luminescent device includes at least one organic material coating element 100. The organic material coating element 100 includes an organic material storage element 106 and a rolling element 104. The organic material storage element 106 has an ejection hole 101. The organic material 110 stored in the organic material storage element 106 can be an organic material adapted for electrons and holes transportation, and luminescence. Such an organic material is adapted for illuminating red light, green light or blue light.

The rolling element 104 is disposed in the ejection hole 101 of the organic material storage element 106. By the rolling 108 of the rolling element 104, the organic material 110 flows out from the organic material storage element 106. The organic material 110 stored in the organic material storage element 106 is coated on a substrate (not shown) by either a contact coating method or a non-contact coating method. The non-contact coating method for coating the organic material 110 is accomplished by the capillarity between the organic material coating element 100 and the substrate.

In an embodiment of the present invention, the rolling element 104 includes a roller 111 and a rolling stick 112 shown in FIG. 3. The rolling stick 112 is disposed along the axis of the roller 111. The roller 111 is rotatably operable in the ejection hole 101 via by the rolling stick. The roller 111 performs the rolling 108 by the rolling stick 112 as an axis so as to flow out the organic material 110.

In another embodiment, the rolling element 104 disposed in the ejection hole 101 can be, for example, a spherical body shown in FIG. 2B. By the rolling 108 of the spherical body, the organic material 110 can be coated on a substrate (now shown) by either a contact coating method or a non-contact coating method.

According to another embodiment, the organic material storage element 106 is coupled to, for example, an organic material supply terminal 114 as shown in FIG. 1, which is connected to the organic material supply apparatus 116. The organic material supply apparatus 116 can continuously supply the organic material 110 and is suitable for mass production. According to yet another embodiment, the organic material supply apparatus 116 can be, for example, an automatic organic material supply apparatus.

FIG. 4 is a schematic drawing showing an exemplary method of coating the organic material on an passive electro-luminescent device according to an embodiment of the present invention.

Referring to FIG. 4, first, a substrate 200 having an electrode layer 202 formed thereon is provided. The organic material 110 is coated apparatus by the apparatus of the present invention over the electrode layer 202. The apparatus includes at least one organic material coating element 100 as shown in FIG. 1. The organic material coating element 100 includes the organic material storage element 106 having the ejection hole 101. The rolling element 104 or the like is disposed in the ejection hole 101 as shown in FIGS. 2A and 2B. The organic material 110 stored in the organic material storage element 106 is coated on the electrode layer 202 by either a contact coating method or a non-contact coating method. The non-contact coating method can be implemented by the capillarity between the organic material coating element 100 and the electrode layer 202.

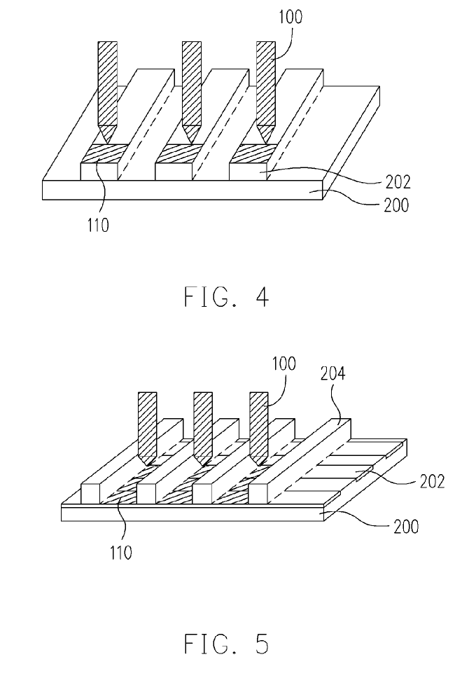

In an embodiment, a rib 204 is formed on the substrate 200 as shown in FIG. 5. The rib 204 is perpendicular to the electrode layer 202 and the organic material 110 is coated in the area between two electrode layers 202.

It should be noted that, while coating the organic material, a plurality of organic material coating elements can be applied so as to form a plurality of organic material patterns. In other words, organic material coating apparatus having one organic material coating element or a plurality of organic material coating elements can be applied for coating so as to reduce the coating process time and to enhance throughput.

It should be noted that organic materials illuminating different colors, for example, red, green or blue, may be coated in different areas of the substrate. In other words, the present invention is not limited to only coating a mono-color organic material and it can be applied to coating multi-color organic materials. Accordingly, the apparatus comprising organic material coating elements of the present invention is capable of coating organic material via a simple coating process and is also capable of reducing coating time.

It should be noted that an organic material within the apparatus of the present invention can be replaced with another organic material if coating with a different organic material is desired. Thus, the apparatus of the present invention is comprehensive providing convenience.

Accordingly, the present invention has following merits:

1. By using the apparatus of the present invention, the organic material can be precisely coated on the luminescent area so as to reduce the wasting of organic material and manufacturing costs.

2. The apparatus of the present invention does not require any sophisticated ink-jet driving control system. The apparatus of the present invention is suitable for mass production and is capable of reducing manufacturing costs.

3. The issue of non-uniformity in coating larger substrate can be reduced.

4. By using the apparatus of the present invention, the process time is substantially reduced compared to the prior art of ink-jet coating method and is suitable for mass production.

Although the present invention has been described in terms of exemplary embodiments, it is not limited thereto. Rather, the appended claims should be constructed broadly to include other variants and embodiments of the invention which may be made by those skilled in the field of this art without departing from the scope and range of equivalents of the invention.

1. An apparatus suitable for coating organic material over an organic electro-luminescent device, comprising:
an organic material storage element, having an ejection hole; and
a rolling element, disposed in the ejection hole such that an organic material stored in the organic material storage element flows out from the organic material storage element by rolling the rolling element.

2. The apparatus of claim 1, wherein the rolling element is a spherical body.

3. The apparatus of claim 1, wherein the rolling element comprises:
a roller; and
a rolling stick, disposed along the axis of the roller and rotatably disposed in the ejection hole via by the rolling stick.

4. The apparatus of claim 1, further comprising an organic material supply apparatus, wherein the organic material storage element is coupled to the organic material supply apparatus.

5. The apparatus of claim 4, wherein the organic material supply apparatus is an automatic organic material supply apparatus.

6. An apparatus suitable for coating organic material over an organic electro-luminescent device, comprising:
a plurality of organic material coating elements, each of the organic material coating elements comprising:
an organic material storage element, having an ejection hole; and
a rolling element, disposed in the ejection hole such that an organic material stored in the organic material storage element flows out by rolling the rolling element; and
an organic material supply apparatus, coupled to the organic material storage elements of the organic material coating elements.

7. The apparatus of claim 6, wherein the rolling element is a spherical body.

8. The apparatus of claim 6, wherein the rolling element comprises:
a roller; and
a rolling stick, disposed along the axis of the roller and is rotatably disposed in the ejection hole via by the rolling stick.

9. The apparatus of claim 6, wherein the organic material supply apparatus is an automatic organic material supply apparatus.

10. A method of coating organic material suitable for forming an organic functional layer of an organic electro-luminescent device, the method comprising:
providing a substrate having an electrode layer formed thereon; and
coating an organic material over the electrode layer by an apparatus comprising:
an organic material storage element, having an ejection hole; and
a rolling element, disposed in the ejection hole such that an organic material stored in the organic material storage element flows out by rolling the rolling element.

11. The method of coating organic material according to claim 10, wherein the method of coating the organic material over the electrode layer is performed by either a contact coating method or a non-contact coating method.

12. The method of coating organic material according to claim 11, wherein the non-contact coating method is accomplished by capillarity between the apparatus and the electrode layer.

13. The method of coating organic material according to claim 10, further comprising:
providing another apparatus with a different organic material for coating the different organic material over the organic electro-luminescent device after the organic material is coated over the electrode layer.

14. A method of coating organic material suitable for forming an organic functional layer of an organic electro-luminescent device, the method comprising:
providing a substrate having an electrode layer formed thereon; and
coating an organic material over the electrode layer for forming a plurality of organic material patterns by an apparatus comprising:
an organic material storage element, having an ejection hole;
a rolling element, disposed in the ejection hole such that an organic material stored in the organic material storage element flows out by rolling the rolling element; and
an organic material supply apparatus, coupled to the organic material storage elements of the organic material coating elements.

15. The method of coating organic material according to claim 14, the method of coating the organic material over the electrode layer is performed by either a contact coating method or a non-contact coating method.

16. The method of coating organic material according to claim 15, wherein the non-contact coating method is accomplished by capillarity between the apparatus and the electrode layer.
